(19) United States
(12) Patent Application Publication
(10) Pub. No.: US 2003/0214527 A1
(43) Pub. Date: Nov. 20, 2003

(54) Television screen saver

(76) Inventor: Veniva Dorothia Paul, Augusta, GA (US)

Correspondence Address: Veniva Dorothie Paul, 2117 Pepperidge Ct., Augusta, GA, 30906, US

(21) Appl. No.: 10/077,702

(22) Filed: May 17, 2002

(51) Int. Cl. G09G 5/00

(52) U.S. Cl. 345/719; 345/867; 345/726

(57) ABSTRACT

Television Screen Saver is an Invention that will change the world and the way it looks on television.

An existing television set is the primary part to the Television Screen Saver program. The television, when turned off, usually has a dark screen. Some people find a blank television screen creepy. The “Television Screen Saver provides visual comfort to anyone who enters the room. The selection of picturesque display item, through the television menu setup program

Television Screen Saver is an Invention that will change the world and the way it looks on television.

An existing television set is the primary part to the Television Screen Saver program. The television, when turned off, usually has a dark screen. Some people find a blank television screen creepy. The “Television Screen Saver provides visual comfort to anyone who enters the room. The selection of picturesque display item, through the television menu setup program.

### BRIEF DESCRIPTION OF THE DRAWINGS

FIG. 1. is a new television screen with an example of a “Television Screen Saver” (TSS) picture.

FIGS. 2, 3, 4 are all samples of different types of pictures that can be down loaded from the menu or from the internet to the Portable Universal Serial Buss (USB) Flash Drive. (See FIG. 7)

FIG. 5 is the television that will have an access port where a Portable USB Flash Drive (memory stick) can be inserted and used with the data from the program software.

FIG. 6 is the Portable USB Flash Drive, which is also a memory stick that can store samples of screen saver pictures downloaded, from the Internet, home pictures scanned into the Personal Computer (PC) and down loaded to the USB Flash Drive.

FIG. 7 is the Main Menu on the television, where the TSS will be located as a function of the setup choice. With the capability to down load information off the computer by some kind of chip in the workings of the TV electronics. With remote capability.

FIG. 8 is a television already in circulation; with TSS on it. The user can access the use of the television screen saver by using the external drive with a 75 OHM series Coaxial 59 cable and 300 75 OHM transformer attachment to the back of the TV. As you will see on FIG. 10.

FIG. 9 is the RAM Chip Box Flash USB drive, RAM Chip Box Flash USB. With a 75 OHM series Coaxial 59 cable and 300 75 OHM transformer attachment.

FIG. 10 is TV without TSS on it, with cable.

FIG. 11 is a repeat display of FIG. 9

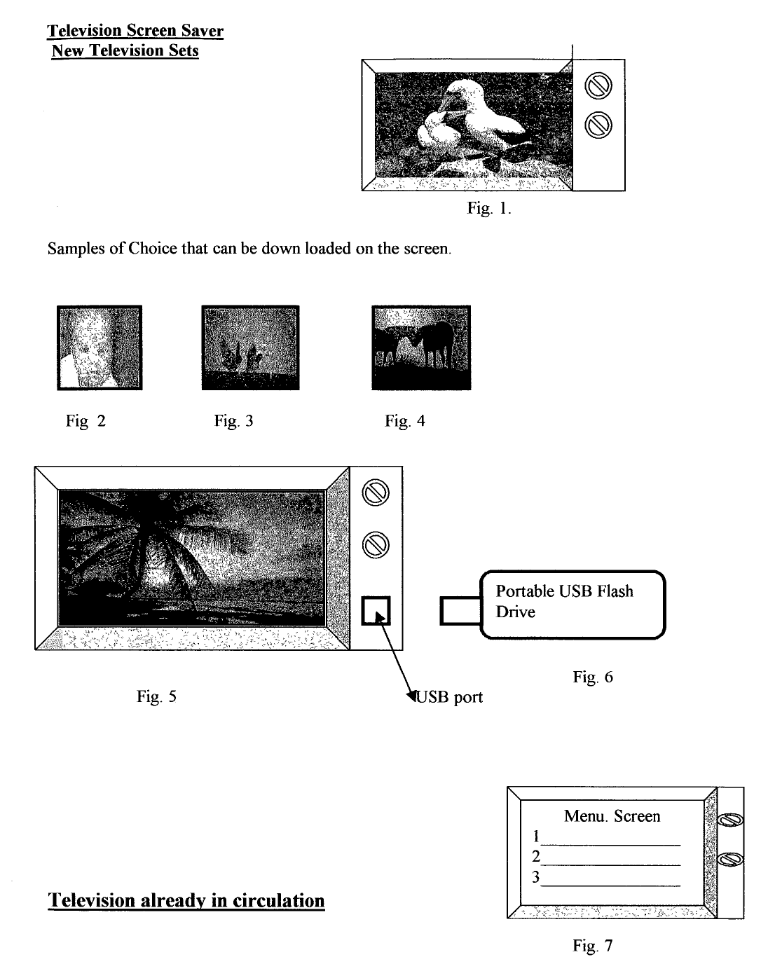

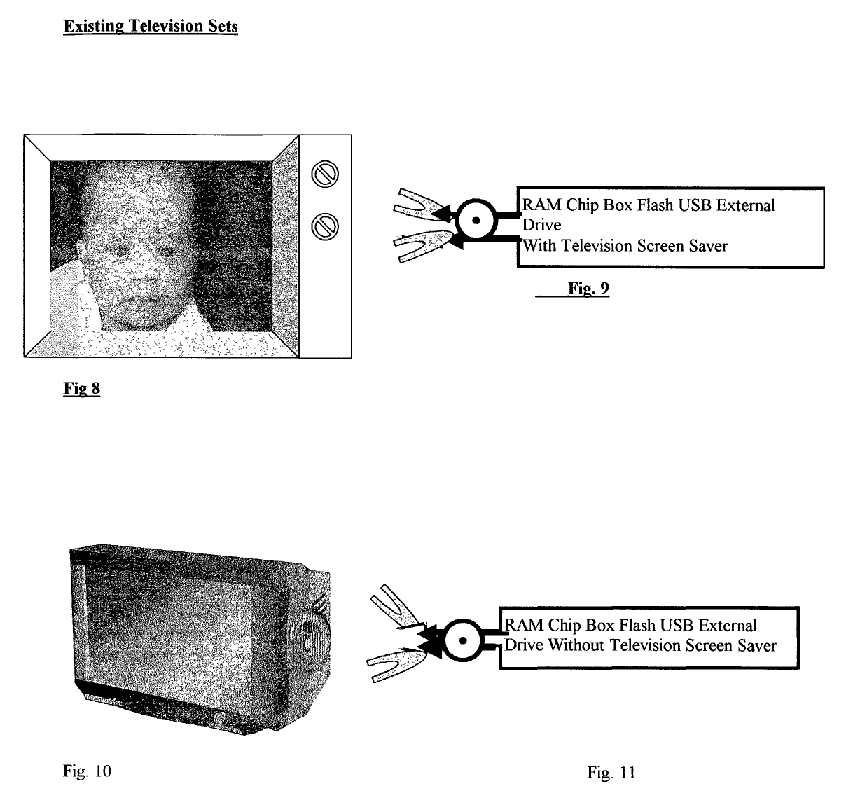

1. Preamble: Television Screen Saver (TSS)
Elements:
a. Television Set
b. Portable Universal Serial Buss (USB) Flash Drive or Memory Stick (Internal Access)
c. 75 OHM Coaxil Cable
(1) Contains still and movable images for screen saver selection
(2) 300 75 OHM Transformer Connector
d. (External) RAM Chip Box Flash USB.
Interconnections:
a. The Portable USB Flash Drive serves as a male connector that is inserted in the USB Port, which resides in a new television. This action allows the downloading of still and movable images to new television sets with menu program access.
b. New televisions can also be made with the item selection inside the main menu program. The selected item then becomes a function setup inside the main menu.
c. The USB Port accepts still and movable image data used to program data files for the TSS selections.
The program process from current television requires the use of a Flash USB Drive 64 Mb or greater which is attached in the rear panel of the television with a cable connector.
Body:
New Television Sets:
A new television set is the primary part to the TSS invention. The television, when turned off, usually has a dark blank screen. This invention will provide people an opportunity to scan images into the Flash USB Drive and transfer or download those images into their television sets for use as a temporary screen saver.
The selection of a picturesque data image, programmed through the television menu setup program, will provide multiple items to be temporarily displayed on the television screen even when the television is turned off. (FIG. 7)
New televisions will have USB Ports that allow transferring of data images by using a Portable USB Flash Drive.
Existing Television Sets:
Current Television set can be adapted to use the TSS program. The use of a RAM Chip Box Flash USB External Drive, 75-OHM coaxial cable, and 2-prong 300-75 OHM transformer connector are the elements necessary to program the main menu to accept the screen saver image.
The RAM Chip Box Flash USB External Drive is the hard drive or brain for the unit and stores images for retrieval for the screen saver.
